(19) United States
(12) Patent Application Publication
(10) Pub. No.: US 2003/0228434 A1
(43) Pub. Date: Dec. 11, 2003

(54) Multilayered polymer tubing and methods of making and using same

(75) Inventors: Michael L. Bailey, Oak Harbor, WA (US); Herbert G. Rettke, Oak Harbor, WA (US)

Correspondence Address: VINSON & ELKINS L.L.P., 1001 FANNIN STREET, 2300 FIRST CITY TOWER, HOUSTON, TX, 77002-6760, US

(73) Assignee: Upchurch Scientific, Inc., Oak Harbor, WA

(21) Appl. No.: 10/358,578

(22) Filed: Feb. 4, 2003

Related U.S. Application Data
(60) Provisional application No. 60/354,176, filed on Feb. 4, 2002.

(51) Int. Cl. B32B 1/08

(52) U.S. Cl. 428/36.91

(57) ABSTRACT

A multilayered tube is provided comprising an inner layer of a tube comprising a first polymer, and a second layer of a tube comprising a second polymer. A catheter is provided comprising a multilayered tube comprising an inner layer of a tube comprising a first polymer, and a second layer of a tube comprising a second polymer. A method is provided for using a catheter for medical diagnostic or analysis, wherein the catheter comprises a multilayered tube comprising an inner layer of a tube comprising a first polymer, and a second layer of a tube comprising a second polymer. A liquid chromatography system is provided comprising tubing which comprises a multilayered tube comprising an inner layer of a tube comprising a first polymer, and a second layer of a tube comprising a second polymer.

### RELATED APPLICATION

This application claims the benefit of U.S. provisional patent application IMPROVED MULTILAYERED POLYMER TUBING AND METHODS OF MAKING AND USING SAME, Serial No. 60/354,176, filed Feb. 4, 2002, hereby incorporated by reference in its entirety, as if set forth below.

### FIELD OF THE INVENTION

The invention relates to multilayered polymer tubing and methods of manufacturing and using such tubing.

### BACKGROUND OF THE INVENTION

Tubing is used to carry fluids in a wide variety of applications. Among other things, polymer tubing is used to carry fluids in medical applications and devices, analytical applications and devices, and so forth. Multilayered polymer tubing is also conventional, and has been used in a wide variety of applications. For example, U.S. Pat. Nos. 6,293,312 B1, 6,180,197 B1, 5,743,304, 5,641,445, 5,638,871, and 5,630,806 all disclose multilayered polymer tubing, using various polymers for various applications. The foregoing patents are hereby incorporated by reference as if fully set forth herein. In addition, U.S. Pat. Nos. 5,855,977, 5,827,587, 5,756,199, 5,658,670, and 5,656,121 disclose various multilayered polymer composites and methods of making same. The foregoing patents are hereby incorporated by reference as if fully set forth herein.

A common problem with conventional multilayered tubing is that a unique combination of properties is sometime desirable for a particular application. For example, in high pressure liquid chromatography (HPLC) applications, a combination of high pressures with the chemical solvents used in the chromatographic analysis means that only a limited number of polymers may be appropriate. For higher pressures or applications where structural strength, torsion resistance, lubricity, or other characteristics are required for a given application, there simply may not be a suitable polymer which can be easily used for tubing in the application. Moreover, biocompatibility is often an important and desirable characteristic, especially in many medical applications and devices, as well as in many HPLC and other analytical applications.

Attached as Appendix 1 hereto are materials describing the various properties and characteristics of several different polymers used in HPLC tubing. Appendix 1 is hereby incorporated by reference as if fully set forth herein. Attached collectively as Appendix 2 hereto are materials describing extruded polymer tubing made from a variety of different polymers and having a variety of useful applications. Appendix 2 is hereby incorporated by reference as if fully set forth herein. The materials of Appendices 1 and 2 describe conventional tubing which is commercially available from Upchurch Scientific of Oak Harbor, Wash.

### SUMMARY OF THE INVENTION

In one preferred embodiment of the invention, there is a multilayered tube comprising an inner layer of a tube comprising a first polymer, and a second layer of a tube comprising a second polymer.

In one preferred embodiment of the invention, the inner layer comprises fluorinated ethylene propylene (FEP), and the second, outer layer comprises polyetheretherketone (PEEK). In yet another alternative embodiment of the invention, the inner layer comprises polytetrafluoroethylene (PTFE) and the outer layer comprises PEEK. In still another embodiment of the invention, the inner tube comprises perfluoro alkoxy alkane (PFA), and the outer tube comprises PEEK. In yet another embodiment of the invention, the inner tube comprises ethylene-tetrafluoroethylene (ETFE), and the outer tube comprises PEEK.

In yet another alternative embodiment, a catheter (or other medical or diagnostic device) comprises a multilayered tube substantially as described herein. In still another alternative embodiment of the invention, an HPLC system comprises at least one multilayered tube substantially as described herein.

### BRIEF DESCRIPTION OF THE DRAWING

FIG. 1 is a cross-sectional view of a multilayered tube in accordance with the present invention.

### DETAILED DESCRIPTION OF THE INVENTION

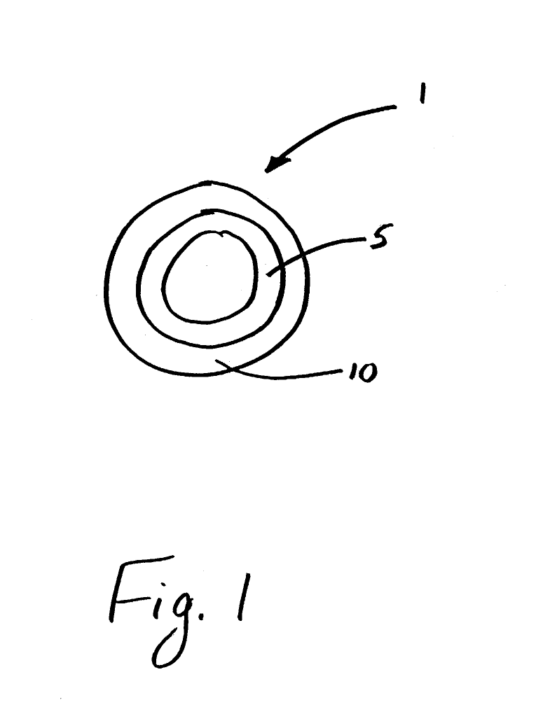

Referring to FIG. 1, a multilayered tube 1 in accordance with the present invention is shown. Tube 1 includes an inner tube 5 and an outer tube 10.

In one preferred embodiment of the invention, the multilayered tube 1 has an inner tube layer 5 made of FEP. We have found that FEP provides useful properties such as flexibility and lubrosity, but may not have sufficient strength or rigidity for certain applications. We have found that PEEK offers good solvent resistance and mid pressure range capabilities, as well as strength. Thus, PEEK is useful as a second, outer tube layer 10 for a variety of applications with demanding conditions. In a preferred embodiment, the inner tube layer 5 is made of FEP. Disposed around the inner FEP layer is a second layer 10 of tubing that is made of PEEK.

In one particular example of various illustrative embodiments of the invention, we used an inner layer 5 made of FEP with an inner diameter of 0.020″ and an outer diameter of 0.039″. This inner layer 5 was extruded through conventional means. This was done by extruding the inner tube 5 of FEP around a metal wire of the desired inner diameter dimension of the tube. We extruded a second, outer tube layer 10 around the first FEP tube layer 5, with the outer layer 10 made of PEEK with an inner diameter of 0.039″ and an outer diameter of 0.062″. After the second, outer layer 10 was extruded, the wire was stretched and removed from the resulting multilayered tube 1. It will be appreciated by those skilled in the art that the dimensions of the various layers of the multilayered tube 1 maybe varied depending on the need to accommodate various pressures to which the resulting tube 1 will be exposed, and/or depending on the desired flexibility or rigidity of the resulting tube, or other desired properties or characteristics.

In other, alternative embodiments of the invention, other materials may be used for the inner and outer layers of the multilayered tube 1. Such materials may be chosen to have high solvent resistance and are therefore particularly useful in certain applications where other materials would quickly corrode. In one particular embodiment, a PTFE layer having an inner diameter of 0.013″ and an outer diameter of 0.039″ was used as the substrate, or inner layer 5. An outer layer 10 made of PEEK and having an inner diameter of 0.039″ and an outer diameter of 0.062″ was used as the second, outer layer 10 of the multilayered tube 1. In still other, alternative embodiments, the inner tube layer 5 can be made of PFA or ETFE, with an outer layer 10 made of PEEK.

While the present invention has been shown and described in its preferred embodiment and in certain specific alternative embodiments, those skilled in the art will recognize from the foregoing discussion that various changes, modifications, and variations may be made thereto without departing from the spirit and scope of the invention as set forth in the claims. Hence, the embodiment and specific dimensions, materials and the like are merely illustrative and do not limit the scope of the invention or the claims herein.

We claim:

1. A multilayered tube substantially as described above.

2. A catheter comprising a multilayered tube substantially as described above.

3. Using a catheter for medical diagnostic or analysis, wherein the catheter comprises a multilayered tube substantially as described above.

4. A liquid chromatography system comprising tubing which comprises a multilayered tube substantially as described above.
